(19) United States
(12) Patent Application Publication
(10) Pub. No.: US 2020/0059993 A1
(43) Pub. Date: Feb. 20, 2020

(54) SOFT ACCESS POINT AND ACCESS POINT IN A WIRELESS NETWORK

(71) Applicant: Huawei Technologies Co., Ltd., Shenzhen (CN)

(72) Inventors: Genadiy TSODIK, Hod Hasharon (IL); Shimon SHILO, Hod Hasharon (IL); Doron EZRI, Hod Hasharon (IL); Avi WEITZMAN, Hod Hasharon (IL); Oded REDLICH, Hod Hasharon (IL); Ping FANG, Shenzhen (CN)

(21) Appl. No.: 16/665,947

(22) Filed: Oct. 28, 2019

Related U.S. Application Data
(63) Continuation of application No. PCT/EP2017/060154, filed on Apr. 28, 2017.

(51) Int. Cl. H04W 88/08; H04W 72/04; H04W 28/24; H04W 16/12; H04W 48/16

(52) U.S. Cl. CPC H04W 88/08; H04W 72/0426; H04W 48/16; H04W 72/0413; H04W 16/12; H04W 28/24

(57) ABSTRACT

A device provides a soft access point in, for example, a wireless network. The device sends, to an access point, a resource request message that includes cluster information about a cluster of network units connected to the device. The access point allocates first resources for communications within the cluster according to the cluster information, and sends to the device a resource allocation message specifying the first resources. The device uses the first resources for communications within the cluster.

### CROSS-REFERENCE TO RELATED APPLICATIONS

This application is a continuation of International Application No. PCT/EP2017/060154, filed on Apr. 28, 2017, the disclosure of which is hereby incorporated by reference in its entirety.

### TECHNICAL FIELD

The invention relates to a device for providing a soft Access Point (AP) in a wireless network. Further, the invention relates to an AP of a wireless network, and to a system including the device and the AP in the same wireless network. The invention also relates to a method for allocating resources in a wireless network, where the method is preferably carried out together by the device for providing the soft AP and the AP.

### BACKGROUND

In future Wi-Fi networks there will be—as is illustrated in FIG. 8—many stations 804 connected to a main AP 800. Some of these stations may function as a device 801 for providing a soft AP for local network units 802 connected to the devices 801 in a cluster 803. Thus, the network can be described as a variety of clusters 803. Each soft AP device 801 managing a cluster 803 is associated directly with the AP 800. The local devices 802 within each cluster 803 are usually not connected directly to the AP 800, so that their management is carried out by the soft AP 801. In such clustered networks, a smart management of internal cluster communications is required, in order to allow efficient behavior of also the main network.

Conventional clustered networks suffer from very low efficiency. Allocating different frequencies means that a frequency-band will be dedicated to each cluster. This frequency-band can then not be used by other clusters or by stations outside of clusters. Spatial reuse techniques have the trade-off between robustness and efficiency, where robustness is usually preferred. Thus, using spatial reuse techniques typically means low probability of allowing internal cluster communications. Accordingly, conventional solutions are not reliable for internal cluster communications, but also efficient in terms of the main network (outside of the clusters).

### SUMMARY

In view of the above-mentioned disadvantages, embodiments of the present invention improve the conventional solutions for clustered networks. For example, exemplary embodiments of the present invention provide a device for providing a soft AP and an AP, respectively, which are able to allocate resources in the network for efficient and reliable internal cluster communications, and also for transmissions in the main network. In particular, a smart management of resources for the internal cluster communications on the one hand, and the main network transmissions (outside of a cluster) on the other hand, is desired. Thereby, the resource management is centralized in the AP.

As described in the present application, exemplary embodiments of the present invention allow an AP to allocate resources to a device providing a soft AP. The allocated resources can be reused for internal communications in a cluster managed by the soft AP providing device.

A first aspect of the present application provides a device for providing a soft AP in a wireless network, the device being configured to send, to an AP of the wireless network, a resource request message including cluster information about a cluster of network units connected to the device, receive, from the AP, a resource allocation message specifying first resources, and use the first resources for communications within the cluster.

Accordingly, the soft AP providing device receives from the AP a resource allocation message specifying the first resources. The device can then reuse the first resources for internal cluster communications. Other stations (network units or devices, which includes other devices for providing a soft AP, and even other devices according to the first aspect), which are outside of the cluster and are connected to the AP, do not recognize that the specified first resources are specifically for use within the cluster. That is, for the main network, the resource allocation message sent by the AP to the soft AP device looks like a regular allocation of resources. In other words, the reuse of the resources for the internal cluster communications is transparent for network stations outside of the cluster, but still associated with the AP.

Since the device knows the resources that it can use for internal cluster communications, the device can also distinguish these first resources from other resources used, for example, for transmissions to the AP. Thus, the device can efficiently manage communications in the cluster on the one hand, and other transmissions to the outside of the cluster on the other hand.

In an implementation form of the first aspect, the resource allocation message further specifies second resources, and the device is configured to use the second resources for uplink (UL) transmissions to the AP.

Accordingly, the device can use distinctively the second resources for transmissions with the AP, and the first resources for communications within the cluster. Nevertheless, it receives advantageously both the first resources and the second resources according to a regular resource allocation message, which is transparent to the main network. Accordingly, the device can efficiently obtain both kinds of resources for the different purposes from the AP.

In a further implementation form of the first aspect, the cluster information includes a cluster size, a desired Quality of Service (QoS) in the cluster, a frequency-band for communications in the cluster, and/or a communication parameter for communications within the cluster.

Including such parameters enables the device to manage internal cluster communications more efficiently and with, for instance, a desired throughput. The device may inform the AP about the nature of the required resources for the internal communications. It can thus receive first resources tailored to its requirements.

In a further implementation form of the first aspect, the first resources include one or more time-frequency slots.

Using such slots has the advantage that a regular frame structure can be preserved, and that embodiments of the present invention are compatible with legacy resource allocation schemes.

In a further implementation form of the first aspect, the resource allocation message further includes an ID (identification) of the device, a power constraint, and/or an interference parameter.

By using such parameters, the device can efficiently manage the internal cluster communications related to the connected network units.

A second aspect of the present application provides an AP of a wireless network, the AP being configured to receive, from a device for providing a soft AP of the wireless network, a resource request message including cluster information about a cluster of network units connected to the device, allocate, according to the cluster information, first resources for communications within the cluster, and send, to the device, a resource allocation message specifying the first resources.

Thus, the management of resources for internal cluster communications is centralized in the AP. This allows the AP to adjust the resources to the special requirements of each soft AP providing device connected to the AP. The AP, and also other network stations connected to the AP, do not need to be aware of the kind of technology that is used within the cluster of the device (e.g., which communication protocol is employed within the cluster), as long as the internal cluster communications do not interfere with network transmissions outside of the cluster, for instance, in other clusters or in the main network. Therefore, the AP is configured to provide a resource allocation scheme that is very flexible, and can be applied to different kinds of clusters.

In an implementation form of the second aspect, the AP is further configured to allocate second resources for UL transmissions from the device to the AP, where the resource allocation message further specifies second resources.

The AP is thus aware of the resources that the device will use for transmissions to the AP, and also of the resources that will not be used for such transmissions to the AP, but rather for internal cluster communications.

In a further implementation form of the second aspect, the AP is further configured to allocate the first resources and/or the second resources according to the cluster information, and according to information about network units connected to the AP and/or a network status.

In this way, the resources can be allocated most efficiently, and specifically tailored to the cluster, but can also be allocated in accordance with requirements of the main network.

In a further implementation form of the second aspect, the AP is further configured to send the resource allocation message by broadcasting it in the wireless network, preferably in a trigger frame.

Therefore, firstly, a regular frame structure can be preserved, and the management of the internal cluster communications can be centralized in the AP for all clusters. Secondly, each device for implementing a soft AP which has requested resources from the AP can obtain its first and/or second resources by selecting them (e.g., according to some kind of rule or indication) from the trigger frame, while disregarding all resources not specified for it.

In a further implementation form of the second aspect, the AP is further configured to determine one or more time-frequency slots as the first resources.

In a further implementation form of the second aspect, the cluster information includes a communication parameter for communications within the cluster, and the AP is further configured to select a duration of the one or more time-frequency slots based on the communication parameter.

Thus, the AP can adjust the first resources to the communication parameter specified by the device. For example, if a payload size is high, a modulation is low, and a supported bandwidth is narrow. In such a case, a long duration is preferably allocated with a small amount of frequency tones. In this example, the communication parameter may include the payload size.

In a further implementation form of the second aspect, the cluster information includes a desired QoS in the cluster, and the AP is further configured to select an amount of time-frequency slots within a defined time period based on the desired QoS in the cluster.

Accordingly, the AP is able to adjust the amount of the allocated resources over a longer time period to the QoS specified by the device. For instance, the AP may allocate resources less frequently for lower QoS and may allocate resources more frequently for a higher QoS. QoS may be defined by one or more parameters, such as bit rate, throughput, delay, availability, jitter or the like.

In a further implementation form of the second aspect, the AP is further configured to not detect UL transmissions from the device in the allocated first resources.

The AP can neglect the detection, because it knows that the first resources are used for internal cluster communications, not for transmissions of the device with the AP. Thus, the AP can detect UL transmissions from the device only in the allocated second resources, and can, thus, more efficiently communicate with the device on the one hand, and lower its resource consumption on the other hand.

A third aspect of the present application provides a system including a device according to the first aspect or one of its implementation forms, and an AP according to the second aspect or one of its implementation forms.

A fourth aspect of the present application provides a method for allocating resources in a wireless network. The wireless network includes an AP and a device for providing a soft AP in the wireless network. The message includes the steps of sending, by the device, a resource request message to the AP, the resource request message including cluster information about a cluster of network units connected to the device, allocating, by the AP according to the cluster information, first resources for communications within the cluster, sending, to the device, a resource allocation message specifying the first resources, and using, by the device, the first resources for communications within the cluster.

The method of the first aspect can be extended by implementation forms that correspond to the implementation forms of the first aspect and the second aspect, respectively. That is, further method steps can be added according to the actions carried out in these implementation forms by the device and the AP, respectively.

Accordingly, the method achieves the same advantages and effects as the device of the first aspect and its implementation forms, and the device of the second aspect and its implementation forms, respectively.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of exemplary embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF THE DRAWINGS

The above-described aspects and implementation forms of the present invention will be explained in the following description of exemplary embodiments in relation to the enclosed drawings, in which:

FIG. 1 shows a device for implementing a soft AP according to an exemplary embodiment of the present invention;

FIG. 2 shows an AP according to an exemplary embodiment of the present invention;

FIG. 3 shows an example for resources allocated for cluster communications parallel to resources for the main network;

FIG. 4 shows communications within the cluster parallel to transmissions within the main network;

FIG. 5 shows an adjustment of resources to a communication parameter;

FIG. 6 shows an adjustment of resources to QoS;

FIG. 7 shows a method according to an exemplary embodiment of the present invention; and

FIG. 8 shows a conventional clustered network.

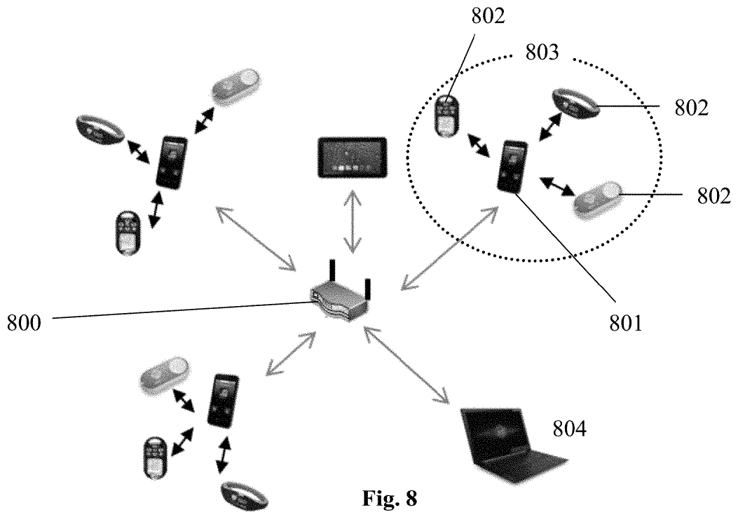

### DETAILED DESCRIPTION

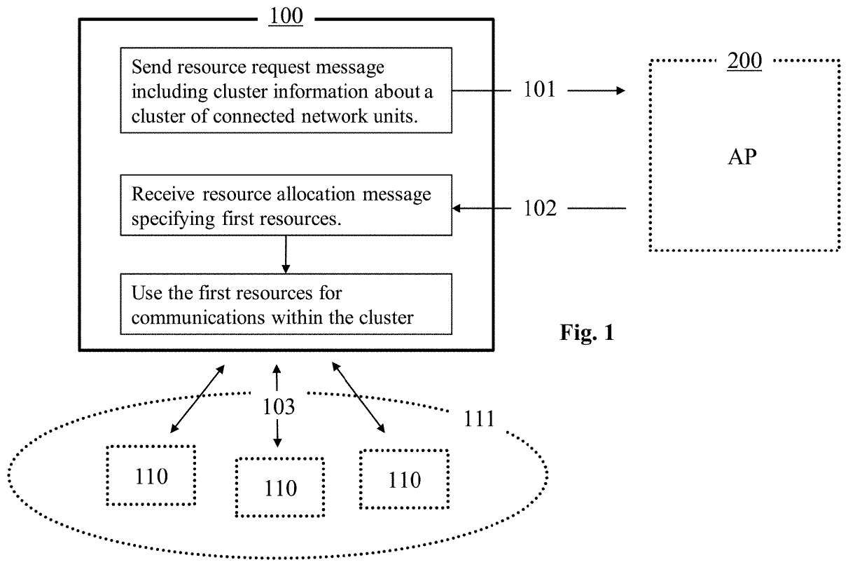

The device 100 according to an exemplary embodiment of the present invention, which is shown in FIG. 1, is configured to provide a soft AP in a wireless network. The device 100 can implement the soft AP, and can thus serve and manage a cluster 111 of network units 110. These network units 110 are at least connected directly to the device 100, but not necessarily also to an AP 200 of the wireless network.

The device 100 is further configured to send to the AP 200 of the wireless network a resource request message 101. The resource request message 101 includes at least cluster information about the cluster 111 of network units 110 connected to the device 100.

The device 100 is also configured to receive, from the AP 200, a resource allocation message 102 in response to the resource request message 101. The resource allocation message 102 specifies at least first resources.

The device 100 is configured to use these first resources received by the resource allocation message 102 for communications 103 within the cluster 111, for example, for communications 103 with or between the network units 110.

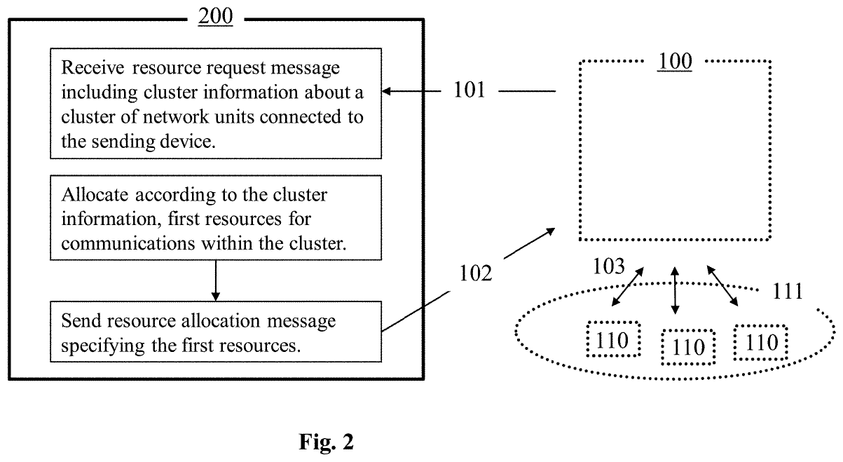

FIG. 2 shows accordingly an AP 200 according to another exemplary embodiment of the present invention in a wireless network. The AP 200 is particularly configured to interact with a device 100 as shown in FIG. 1. To this end, the AP 200 is configured to receive from the device 100 a resource request message 101 including cluster information about a cluster 111 of network units 110 connected to the device 100.

The AP 200 is then further configured to allocate, according to the received cluster information, first resources for communications 103 within the cluster 111 of the device 100.

The AP 200 is configured to send a resource allocation message 102 to the device 100 specifying the allocated first resources.

An exemplary embodiment of the present invention also includes a system including at least one device 100 as shown in FIG. 1, and at least one AP 200 as shown in FIG. 2. The device 100, the AP 200 and the system, respectively, can be employed for implementing a more efficient and smarter allocation and management of resources within a wireless network, particularly resources both for internal cluster communications 103 and other transmissions or communications in the main network (i.e. outside this specific cluster 111).

As an example for other transmissions in the network, the resource allocation message 102 sent from the AP 200 to the device 100 may specify second resources, where the device 100 is configured to use the second resources for UL transmissions to the AP 200. Thus, different kinds of resources are allocated and sent by the AP 200 to the device 100, namely on the one hand the first resources for internal cluster communications 103, and on the other hand the second resources for conventional transmissions with the AP 200.

Each of the soft AP providing devices 100 in the wireless network can inform the AP 200 about its required resources for internal cluster communications 103, including e.g., time, frequency-band, and transmission parameters (such as, e.g., payload size, MCS (modulation coding scheme), power, data type, etc.). The AP 200 can accordingly allocate and distribute different first resources to these devices 100 for each cluster 111 according to those requirements and/or according to a status of the main network. For the main network, this resource distribution appears like a conventional allocation and distribution of resources. That is, the reuse of the first resources by a device 100 for internal communications 103 in a cluster 111, is transparent for other stations associated with the AP 200. Only the specific device 100 knows what the first resources are for. For instance, the AP 200 can inform—within a trigger frame—that a certain device 100 has a resource allocation in a next UL frame, while, however, this device 100 will use this resource allocation for internal communications 103 in its cluster 111, and not for UL.

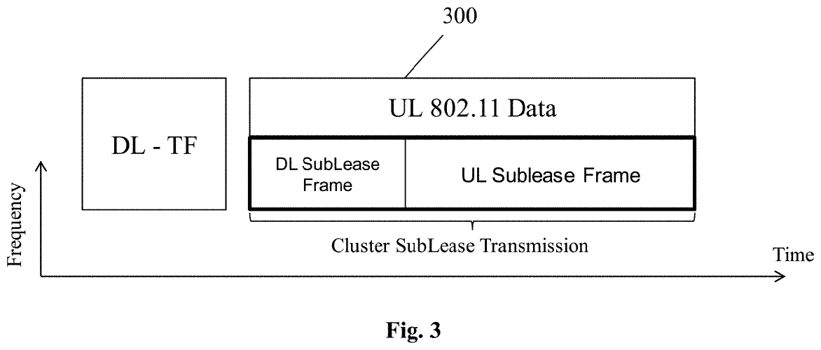

A specific resource allocation is shown in FIG. 3. Preferably, the resources are allocated by the AP 200 as time-frequency slots 300. In FIG. 3, Downlink (DL) means from the AP 200 to an associated network unit or device (network station) including the device 100. UL means from an allocated station to the AP 200. TF means ‘trigger frame’. Here, resources for internal cluster communications 103 (labelled ‘Cluster SubLease Transmission’) are allocated in specifically an UL time-frequency slot. In this way, reuse of the resources for communications 103 within the cluster 111 is enabled, while furthermore a regular frame structure is preserved, all resource management is done by the AP 200, i.e. a centralized management approach is implemented, and the same frequency band may be reused for the communications 103 within the clusters 11.

The allocation of resources may particularly be carried out according to the following rules and principles. The allocation of the resources, preferably of the time-frequency slots 300, is always defined by the AP 200. Further, the allocated first resources are available for the device 100 and its cluster members 110 only. Further, each device 100 manages the network units 110 within its own cluster 111, while it otherwise adheres to the AP 200 scheduling (e.g., wake-up of the device, only when transmission is allowed, adjustment of transmit times, power, etc.). Further, a minimal allocated bandwidth and time may be considered to reduce scheduling complexity. Finally, it is ensured that the signals transmitted within a cluster 111 cannot interfere with other signals, for instance, with transmissions in the main network or with communications in another cluster 111 (which is similar to spatial reuse principles).

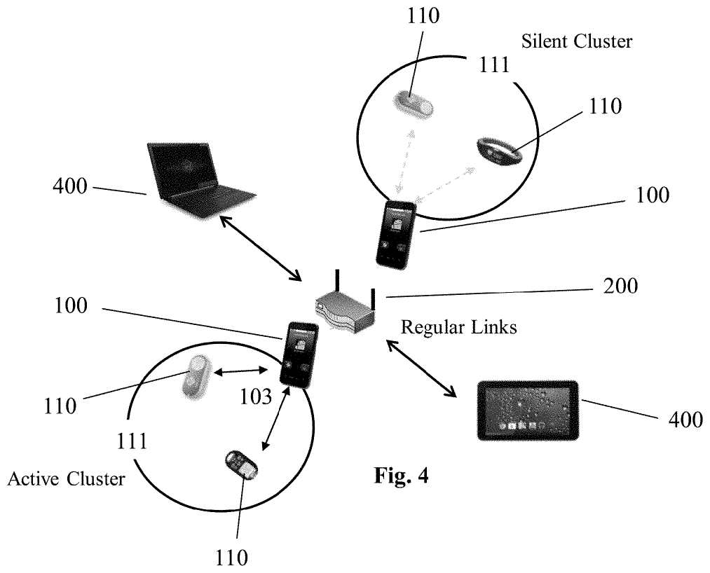

FIG. 4 shows schematically the communications 103 within clusters 111 of network units 110 (an active cluster 111 and a silent cluster 111 of two devices 100 are shown), parallel with transmissions in the main network. The AP 200 preferably connects directly with the devices 100 for providing the soft AP, and with regular network stations 400. The network units 110 connected to the soft AP devices 100 are in this case not directly corrected to the AP 200, but are managed in the clusters 111 by the devices 100. In order to distribute the first resources for the respective clusters 111 to the individual devices 100, the following information exchange is preferred.

The device 100 provides the AP 200 with the resource request message 101, which preferably contains the following information. An indication that it is a device 100 that provides a soft AP, a cluster size (e.g., an amount of network units 110 in the cluster 111), a desired QoS (e.g., delay, error rate, bit rate, availability and/or jitter) within the cluster 111, and one or more main communications parameters within the cluster 111. A main communication parameter may include a payload size, MCS, power, a data type, etc.

The resource request massage 101 with such information enables the AP 200 to allocate first resources to a device 100, such that the device 100 can manage its internal cluster communications 103 efficiently, and can achieve a desired throughput.

The AP 200 responds to the device 100 with a resource allocation message 102, which preferably includes at least the following information. An ID of the device 100 that provides the soft AP, such that the device 100 can determine (e.g., from a trigger frame) that the allocated first resources are intended for its use. The device 100 may disregard resources allocated in correspondence with another ID. Thereby, the allocation of resources for internal cluster communications 103 of a certain device 100 is transparent for all other devices 100 and also for other stations 400. A time-frequency slot definition, such that the device 100 is enabled to easily obtain the first resources. One or more power constraints and/or interference parameters (for instance, how much interference is allowed in the current communication). All selected information is preferably broadcast by the AP 200 to all stations 400 and devices 100 connected to it, more preferably is distributed in a trigger frame as shown in FIG. 3.

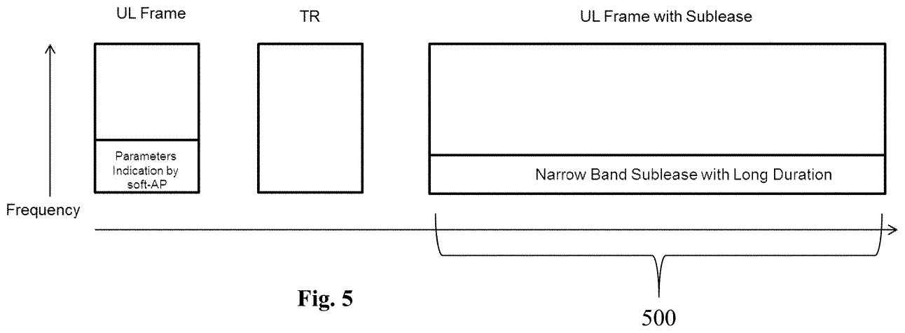

FIG. 5 shows how the AP 200 can adjust the allocation of the first resources for a device 100 to one or more communication parameters. In particular, the AP 200 can adjust a size of a time-frequency slot 300 to the communication parameter, which may previously be specified by the device 100 in the resource request message 101. For instance, a payload size may be specified by the device 100 as communication parameter. This may be done in an UL frame, i.e. the resource request message 101 is an UL transmission to the AP 200. If the payload size is specified to be high, a modulation is low, and a supported bandwidth is narrow. Accordingly, a longer duration 500 needs to be allocated for the first resources (i.e. a time-frequency slot with a longer time dimension needs to be used), while a frequency tone may be smaller. In FIG. 5 this is indicated by ‘Narrow Band Sublease with Long Duration’, the duration 500 of which is long.

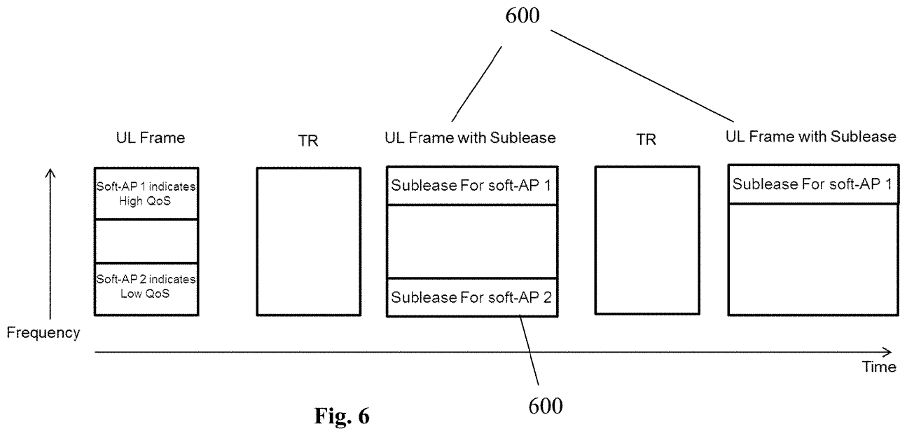

FIG. 6 shows another possible adjustment of the allocation of the first resources by the AP 200, namely to one or more QoS requirements (e.g., bit rate, error rate, delay, availability, jitter etc.). The AP 200 can adjust particularly the amount of the allocated first resources over a longer time period to the QoS requirements, which may be specified by the device 100 in its resource request message 101. For instance, the AP 200 could allocate less frequently the first resources (i.e. could allocate a lower amount 600 of first resources within a defined time period) for a lower required QoS, or could allocate more frequently the first resources (i.e. could allocate a higher amount 600 of first resources in the same defined time period) for a higher required QoS. In FIG. 6 this is indicated by ‘Sublease For soft-AP 1’, which is allocated with an amount 600 of two (twice) within a defined time period, and by ‘Sublease For soft-AP 1’, which is allocated with an amount 600 of one (once). This is the result of a first device 100 (soft-AP 1) indicating ‘High QoS’ during the UL frame, and a second device 100 (soft-AP 2) indicating low QoS' during the UL frame.

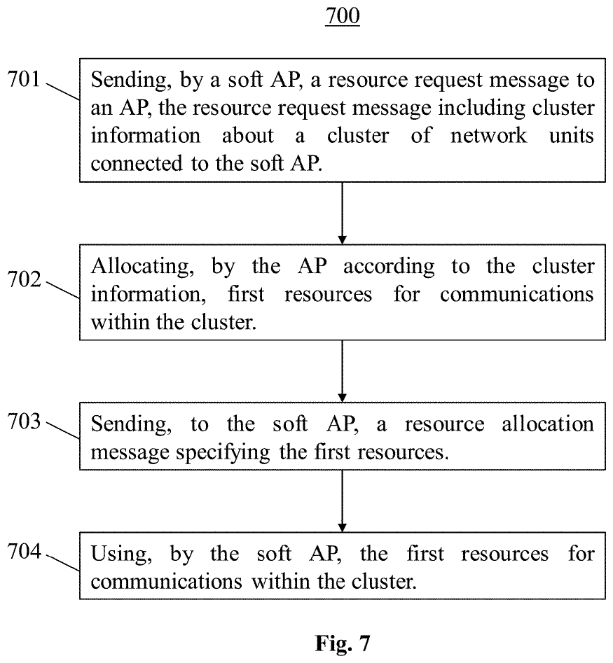

FIG. 7 shows a method 700 according to an exemplary embodiment of the present invention. In an operation 701, the method 700 includes sending, by a soft AP, a resource request message to an AP, the resource request message including cluster information about a cluster of network units connected to the soft AP. In an operation 702, the method 700 includes allocating, by the AP according to the cluster information, first resources for communications with the cluster. In an operation, 703, the method 700 includes sending to the soft AP, a resource allocation message specifying the first resources. In an operation 704, the method 700 includes using, by the soft AP, the first resources for communication within the cluster.

Aspects of embodiments of the present invention resolve the conventional trade-off between efficiency and robustness of resource allocation. Also, coexistence with the main network is well enabled, since the AP 200 manages all resources, and indicates what the guidelines for the internal cluster transmissions 103 are. Each device 100 can adjust its communication parameters accordingly, for example, a transmission power, guard band, time alignment, etc. The AP 200 can prioritize its resource allocation management, i.e. it can adjust the allocations for different clusters 111 to the requirements of each cluster 111, and also to the main network conditions and to general constraints. Finally, internal communications 103 within a cluster 111 should include a legacy part, in order to ensure that the link is protected from external interference.

Embodiments of the present invention allow an efficient coexistence of soft AP managed clusters 111 and a wireless main network, with no need of specifying additional resources. Furthermore, the idea of a centralized management by the AP 200 leads to a network scheduling that is efficient and robust. Embodiments of the present invention can be combined with other techniques, which solve similar issues, or with other network technologies.

The present invention has been described in conjunction with various embodiments as examples as well as implementations. However, other variations can be understood and effected by those persons skilled in the art and practicing the claimed invention, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A device for providing a soft access point in a wireless network, the device being configured to:
send, to an access point of the wireless network, a resource request message including cluster information about a cluster of network units connected to the device,
receive, from the access point, a resource allocation message specifying first resources, and
use the first resources for communications within the cluster.

2. The device according to claim 1, wherein:
the resource allocation message further specifies second resources, and
the device is configured to use the second resources for uplink, transmissions to the access point.

3. The device according to claim 1, wherein the cluster information comprises a cluster size, a desired quality of service in the cluster, a frequency-band for communications in the cluster, or a communication parameter for communications within the cluster.

4. The device according to claim 1, wherein the first resources comprise one or more time-frequency slots.

5. The device according to claim 1, wherein the resource allocation message further includes an identification of the device, a power constraint, or an interference parameter.

6. An access point of a wireless network, the access point being configured to:
receive, from a device for providing a soft access point of the wireless network, a resource request message including cluster information about a cluster of network units connected to the device,
allocate, according to the cluster information, first resources for communications within the cluster, and
send, to the device, a resource allocation message specifying the first resources.

7. The access point according to claim 6, further configured to allocate second resources for uplink transmissions from the device to the access point,
wherein the resource allocation message further specifies second resources.

8. The access point according to claim 6, further configured to allocate the first resources or the second resources according to the cluster information, information about network units connected to the access point, or a network status.

9. The access point according to claim 6, further configured to send the resource allocation message by broadcasting the resource allocation message in the wireless network.

10. The access point according to claim 6, further configured to determine one or more time-frequency slots as the first resources.

11. The access point according to claim 10, wherein:
the cluster information comprises a communication parameter for communications within the cluster, and
the access point is further configured to select a duration of the one or more time-frequency slots based on the communication parameter.

12. The access point according to claim 10, wherein:
the cluster information comprises a desired quality of service in the cluster, and
the access point is further configured to select an amount of the time-frequency slots within a defined time period based on the desired quality of service in the cluster.

13. The access point according to claim 6, further configured to not detect uplink transmissions from the device in the allocated first resources.

14. A system comprising the device according to claim 1 and the access point of the wireless network, the access point being configured to:
receive, from the device a resource request message including cluster information about a cluster of network units connected to the device,
allocate, according to the cluster information, first resources for communications within the cluster, and
send, to the device, a resource allocation message specifying the first resources.

15. A method for allocating resources in a wireless network, the wireless network comprising an access point, and a device for providing a soft access point in the wireless network, the method comprising the steps of:
sending, by the device, a resource request message to the access point, the resource request message including cluster information about a cluster of network units connected to the device,
receiving, by the device, a resource allocation message, from the access point, the resource allocation message specifying first resources and being generated based on the cluster information, and
using, by the device, the first resources for communications within the cluster.

16. The access point according to claim 9, further configured to send the resource allocation message by broadcasting the resource allocation message in the wireless network in a trigger frame.
